(19) United States
(12) Patent Application Publication
(10) Pub. No.: US 2006/0050768 A1
(43) Pub. Date: Mar. 9, 2006

(54) Method and protective circuit for monitoring the temperature of electric motors cooled by a coolant

(76) Inventors: Friedrich Kriwan, Forchtenberg (DE); Paul Lyons, Kunzelsau (DE)

Correspondence Address: JOHN MCCULLOCH, 5291 COLONY DRIVE NORTH, 1ST FLOOR, SAGINAW, MI, 48603, US

(21) Appl. No.: 11/216,934

(22) Filed: Aug. 31, 2005

(30) Foreign Application Priority Data
Sep. 6, 2004 (DE) 10 2004 043 059.4

(51) Int. Cl. G01K 1/14

(52) U.S. Cl. 374/141

(57) ABSTRACT

The invention relates to a method and a protective circuit for monitoring the temperature of electric motors cooled by a coolant, wherein a sensor signal corresponding to the temperature of the motor is generated and evaluated by way of at least one PTC thermistor, an output signal being generated when the sensor signal exceeds a predetermined threshold value. Furthermore, the rate of change of the sensor signal is also determined, whereby the threshold value at which the output signal is generated is altered as a function of the rate of change.

The invention relates to a method and to a protective circuit for monitoring the temperature of electric motors cooled by a coolant, wherein a sensor signal corresponding to the temperature of the motor is generated and evaluated by way of at least one PTC thermistor, an output signal being generated when the sensor signal exceeds a predetermined threshold value.

In the case of known electric motors cooled by a coolant there is risk of overheating, whether it be due to coolant shortage, blocked valves or even a jammed rotor. In this case irreversible damage can occur. This risk of overheating is usually encountered when the motor is switched off when a limiting value for the temperature is exceeded. For this purpose it is known for the temperature of the motor winding to be determined by way of a PTC thermistor wound into the winding and for the motor to be switched off when a predetermined limiting value is exceeded.

This method has proved worthwhile in the art for the majority of operating situations. However, it has had to be recognised that in certain situations the switch-off signal is generated too late so that damage to the motor occurred.

The object of the invention, therefore, is to make improvements to the method and to the protective circuit for monitoring the temperature of electric motors cooled by a coolant.

This object is achieved according to the invention by the features of Claims 1 and 5 respectively.

In the method according to the invention for monitoring the temperature of electric motors cooled by a coolant a sensor signal corresponding to the temperature of the motor is generated and evaluated by way of at least one PTC thermistor, an output signal being generated when the sensor signal exceeds a predetermined threshold value. Furthermore, the rate of change of the sensor signal is also determined, wherein the threshold value at which the output signal is generated is altered as a function of the rate of change.

The protective circuit according to the invention for monitoring the temperature of electric motors cooled by a coolant basically comprises at least one PTC thermistor which generates a sensor signal corresponding to the temperature of the motor and an evaluation device which generates an output signal when the sensor signal exceeds a predetermined threshold value.

Furthermore, the evaluation device has means for determining the rate of change of the sensor signal and means for adapting the threshold value as a function of the rate of change.

Further embodiments of the invention are the subject matter of the subordinate claims.

According to a preferred embodiment the output signal is immediately generated when the rate of change is greater than a predetermined value.

According to a further embodiment at least a first and a second threshold value are predetermined, wherein in a range of the rate of change of the sensor signal from 0 to x the first threshold value is used and in a range of the threshold value from x to y, where y>x, the second threshold value is used for the generation of the output signal, and at a rate of change greater than y an output signal is generated immediately.

In order to determine the rate of change the sensor signal is checked at specific clock intervals.

Further advantages and embodiments of the invention are explained in greater detail with reference to the description of an embodiment and the drawings, in which:

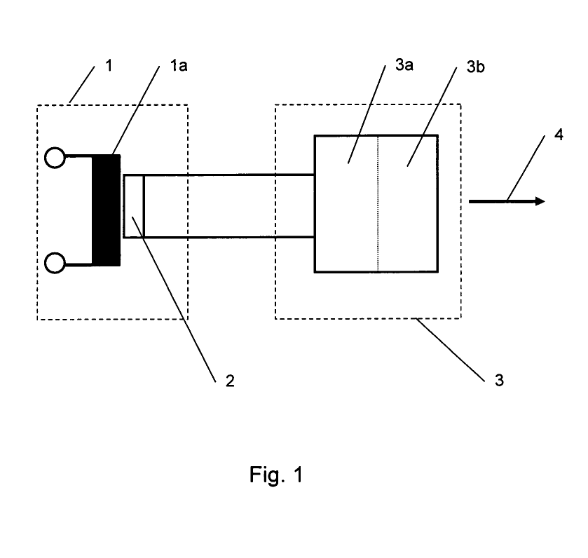

FIG. 1 shows a schematic representation of the protective circuit,

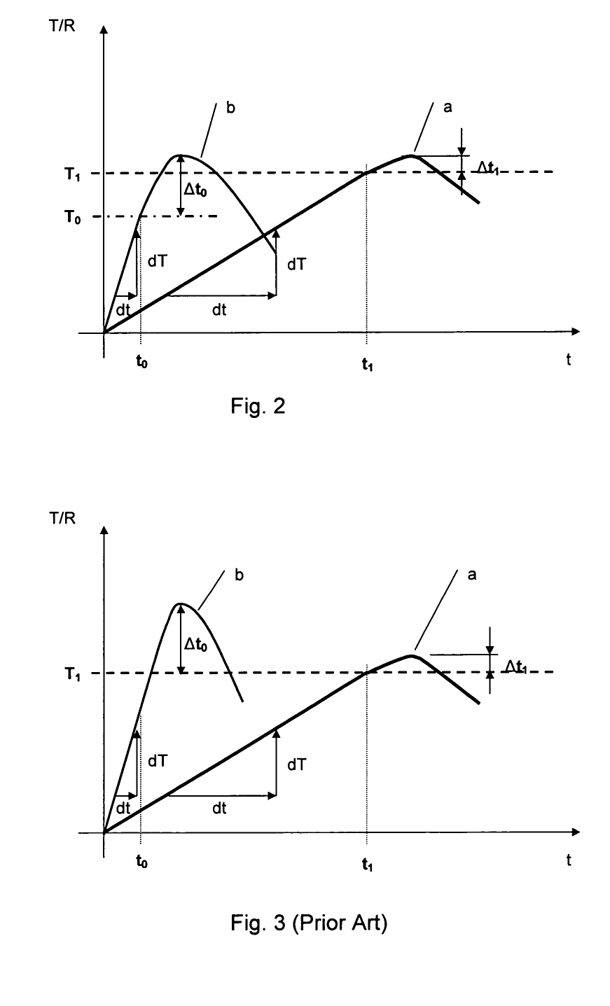

FIG. 2 shows a temperature/resistance time diagram according to the invention, and

FIG. 3 shows a temperature/resistance time diagram according to the prior art.

The protective circuit shown in FIG. 1 for monitoring the temperature of an electric motor 1 cooled by a coolant basically comprises at least one PTC thermistor 2 and an evaluation device 3. The PTC thermistor 2 generates a sensor signal corresponding to the temperature of a component. Naturally, within the scope of the invention a plurality of PTC thermistors can also be connected to one another. The PTC thermistor or thermistors 2 are for example embedded in the winding 1a of the electric motor.

In the critical temperature range the PTC thermistor produce an exponential change in resistance which is proportional to the increase in temperature. The sensor signal is processed in the evaluation device 3, whereby the evaluation device 3 generates an output signal 4 when the sensor signal exceeds a predetermined threshold value.

The evaluation device also has means 3a for determining the rate of change dT/dt or dR/dt of the sensor signal and means 3b for adaptation of the threshold value as a function of the rate of change. The means 3a in particular comprise a clock by means of which at predetermined clock intervals, for example every 200 ms, the sensor signal is checked, filtered and compared with the preceding value.

The differences between the invention and the prior art will now be explained in greater detail below with reference to FIGS. 2 and 3.

In the temperature/resistance time diagram according to FIG. 3 the time is shown to the right and towards the top the temperature or the resistance is shown on the basis of the sensor signal. The curve a represents the usual temperature/resistance increase in the case of a disruption. At the time t₁ the sensor signal reaches a predetermined threshold value T₁ with the consequence that the evaluation device generates an output signal 4. This output signal can for example be a switch-off signal for the motor, a warning signal or the like. Even if at the time t₁ the evaluation device immediately switches off the motor, there is usually a so-called temperature overrun, i.e. the temperature of the motor winding continues to rise by the amount Δt₁. This temperature overrun is usually also taken into account when the threshold value T₁ is fixed.

In the tests on which the invention is based it has been demonstrated that the temperature overrun Δt₁ is also a function of the rate of change of the sensor signal.

The curve b represents another operational case in which the sensor signal changes substantially more quickly relative to the time. The threshold T₁ is reached after the time t₀. Here, however, due to the higher rate of change the temperature overrun Δt₀ is substantially greater. Thus the temperature of the electric motor to be monitored, in particular the temperature of the motor winding thereof, is heated significantly above the predetermined threshold value T₁, which can lead to irreversible damage to the motor. In the case of an electric motor cooled by a coolant there is then in particular also a risk that due to the overheating burning of individual components of the winding insulation occurs and thus the coolant becomes contaminated. The consequence of this is that the coolant can become unusable, resulting in the need for costly repair work.

The situation in the protective circuit according to the invention is now shown in FIG. 2.

According to the invention the rate of change dT/dt or dR/dt of the sensor signal is monitored continuously. The novel feature lies in the fact that the threshold value at which the output signal is generated is changed as a function of the rate of change. Thus it is provided that the output signal is generated when the rate of change dT/dt (or dR/dt)>y. In the illustrated embodiment according to FIG. 2 this is the case in the curve b, so that the output signal is already generated at the time t₀. However, even if there is a relatively great temperature overrun Δt₀, the maximum temperature of the monitoring device is always still within the tolerable range, since the output signal is already generated at a lower temperature T₀.

If the rate of change dT/dt (dR/dt) is below the predetermined value y, as is the case in the curve a, the output signal is only generated at the predetermined threshold value T₁.

Naturally it is conceivable within the scope of the invention that not only one but at least a first and a second fixed threshold value are predetermined, whereby in a range of the rate of change of the sensor signal from 0 to x the first threshold value is used and in a range of the rate of change from x to y, where y>x, the second threshold value is used for the generation of the output signal. Furthermore, however, at a rate of change>y an output signal should be generated immediately.

In a practical embodiment the sensor 2 for example supplies a temperature-dependent resistance value R. Furthermore, at predetermined clock intervals of for example 200 ms this resistance value is checked, filtered and compared with the predetermined resistance value. Depending upon the change in resistance the first or, if it exists, a second threshold value is used for the generation of the output signal. If the change in resistance exceeds a predetermined value the output signal is generated immediately.

By taking account of the rate of change of the sensor signal and thus of the possibility of being able to change the threshold value at which the output signal is generated, it is possible to react more quickly to specific critical operating situations, so that the monitored device is reliably protected against excessive thermal load.

1. Method for monitoring the temperature of electric motors cooled by a coolant, wherein a sensor signal corresponding to the temperature of the motor (1) is generated and evaluated by way of at least one PTC thermistor (2), an output signal being generated when the sensor signal exceeds a predetermined threshold value, characterised in that the rate of change (dT/dt, dR/dt) of the sensor signal is also determined, whereby the threshold value at which the output signal is generated is changed as a function of the rate of change.

2. Method as claimed in claim 1, characterised in that the output signal is immediately generated when the rate of change (dT/dt, dR/dt) is greater than a predetermined value.

3. Method as claimed in claim 1, characterised in that at least a first and a second threshold value are predetermined, whereby in a range of the rate of change (dT/dt, dR/dt) of the sensor signal from 0 to x the first threshold value is used and in a range of the rate of change from x to y, where y>x, the second threshold value is used for the generation of the output signal, and in the event of a rate of change greater than y an output signal is generated immediately.

4. Method as claimed in claim 1, characterised in that in order to determine the rate of change (dT/dt, dR/dt) the sensor signal is checked at a predetermined clock interval.

5. Protective circuit for monitoring the temperature of electric motors cooled by a coolant, with
a. at least one PTC thermistor (2) which generates a sensor signal corresponding the temperature of the motor (1), and
b. an evaluation device (3) which generates an output signal (4) when the sensor signal exceeds a predetermined threshold value,
characterised in that the evaluation device has means (3a) for determining the rate of change (dT/dt, dR/dt) of the sensor signal and means (3b) for adaptation of the threshold value as a function of the rate of change.

6. Protective circuit as claimed in claim 1, characterised in that the means (3a) for determining the rate of change (dT/dt, dR/dt) comprise a clock.
